(19) United States
(12) Patent Application Publication
(10) Pub. No.: US 2026/0228881 A1
(43) Pub. Date: Aug. 6, 2026

(54) DEVICE FOR DETECTING WAFER DEFECTS BASED ON BRIGHTNESS INFORMATION AND METHOD THEREOF

(71) Applicant: SAMSUNG ELECTRONICS CO., LTD., Suwon-si (KR)

(72) Inventors: Daeseo PARK, Suwon-si (KR); Kyungsoo KIM, Suwon-si (KR); Jeonghyeon GONG, Suwon-si (KR)

(73) Assignee: SAMSUNG ELECTRONICS CO., LTD., Suwon-si (KR)

(21) Appl. No.: 19/431,492

(22) Filed: Dec. 23, 2025

(30) Foreign Application Priority Data
Feb. 4, 2025 (KR) 10-2025-0013935
May 8, 2025 (KR) 10-2025-0059906

(51) Int. Cl. G06T 7/00; G01N 21/88; G01N 21/95; G06T 7/13

(52) U.S. Cl. CPC G06T 7/001; G01N 21/8806; G01N 21/9501; G06T 7/13; G06T 2207/30148

(57) ABSTRACT

A method of detecting a defect of a semiconductor device in a wafer includes obtaining an inspection image corresponding to the semiconductor device and position information representing positions of a plurality of test element groups in the wafer, identifying a masking region and a non-masking region from the inspection image, based on the position information, generating brightness information corresponding to a boundary region included in the inspection image, and detecting a defect of the semiconductor device by detecting a defect region in the non-masking region, based on the brightness information.

### CROSS-REFERENCE TO RELATED APPLICATION

This application is based on and claims priority to Korean Patent Application No. 10-2025-0013935, filed on February 4, 2025, in the Korean Intellectual Property Office, and Korean Patent Application No. 10-2025-0059906, filed on May 8, 2025, in the Korean Intellectual Property Office, the disclosures of which are incorporated by reference herein in their entireties.

### BACKGROUND

The present disclosure relates to a defect detection device and method for semiconductor devices, and more particularly, to a device which detects a lateral crack occurring in a semiconductor device.

In a semiconductor manufacturing process, a dicing process of dicing a wafer into a plurality of individual chips is performed. A lateral crack may occur in a semiconductor chip in a process of dicing a wafer along a scribe line of the wafer. Because a lateral crack is formed in a chip, there is a problem where it is difficult to defect a lateral crack through a general appearance inspection method.

As semiconductor devices are highly and continuously integrated, a lateral crack occurring in a chip may adversely affect the electrical characteristic or reliability of semiconductor devices. This may be a main cause of decreasing the final yield rate of a process. A conventional inspection method is mainly performed on an appearance, and due to this, has a limitation in early detecting whether there is a crack occurring in the inside. Therefore, it is required to develop a technical method which early detects and screens a lateral crack occurring in a wafer dicing process.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a method which may provide early detection of a lateral crack occurring in a wafer in a dicing process.

Additional aspects will be set forth in part in the description which follows and, in part, will be apparent from the description, or may be learned by practice of the presented embodiments.

According to an aspect of an example embodiment, a method of detecting a defect of a semiconductor device in a wafer may include obtaining an inspection image corresponding to the semiconductor device and position information representing positions of a plurality of test element groups in the wafer, identifying a masking region and a non-masking region from the inspection image, based on the position information, generating brightness information corresponding to a boundary region included in the inspection image, and detecting a defect of the semiconductor device by detecting a defect region in the non-masking region, based on the brightness information.

According to an aspect of an example embodiment, a device for detecting a defect of a semiconductor device in a wafer may include a stage configured to have the semiconductor device loaded thereon or unloaded therefrom, an image generating device configured to emit light onto the semiconductor device and generate an inspection image, based on light reflected from the semiconductor device, and an image analysis device configured to analyze the image for inspect, based on position information representing positions of a plurality of test element groups in the wafer, where the image analysis device may be configured to identify a masking region and a non-masking region from the inspection image, based on the position information, generate brightness information corresponding to a boundary region included in the inspection image, and based on a difference between the second average gray value and the first average gray value being greater than a defect reference gray value, determining the second region as the defect region.

According to an aspect of an example embodiment, a non-transitory computer-readable storage medium may store instructions that, when executed by a processor, cause the processor to obtain position information representing positions of a plurality of test element groups and an inspection image corresponding to a semiconductor device, identify a masking region and a non-masking region from the inspection image, based on the position information, generate brightness information corresponding to a boundary region included in the inspection image, detect a defect of the semiconductor device by detecting a defect region in the non-masking region, based on the brightness information.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a perspective view schematically illustrating a wafer according to an embodiment;

FIG. 2 is a plan view illustrating an enlarged portion of a wafer according to an embodiment;

FIGS. 3A, 3B and 3C are cross-sectional views illustrating a cross-sectional surface of a portion of a wafer according to an embodiment;

FIG. 4 is a diagram illustrating a crack occurring in a wafer according to an embodiment;

FIG. 5 is a block diagram illustrating a defect detection device for detecting a defect of a semiconductor device, according to an embodiment;

FIG. 6 is a block diagram illustrating configurations of an optical imaging device and an image analysis device, according to an embodiment;

FIG. 7 is a diagram illustrating an example where an optical imaging device emits light and receives reflected light according to an embodiment;

FIG. 8 is a diagram illustrating an inspection-targeted region of a wafer imaged by an optical imaging device according to an embodiment;

FIG. 9 is a diagram illustrating an inspection image according to an embodiment;

FIGS. 10A, 10B and 10C are diagrams illustrating a method of detecting a defect of a semiconductor chip, according to an embodiment;

FIG. 11 is a diagram illustrating a method of detecting a defect of a semiconductor device, according to an embodiment;

FIG. 12 is a flowchart illustrating a method of detecting a defect of a semiconductor device, according to an embodiment;

FIG. 13 is a flowchart illustrating a method of detecting a defect of a semiconductor device, according to an embodiment;

FIG. 14 is a flowchart illustrating construction of an analog-to-digital converter (ADC) model according to an embodiment; and

FIG. 15 is a block diagram illustrating a system according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, "at least one of a, b, and c," should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

Terms such as first, second, etc. may be used to describe various components, but are used only for the purpose of distinguishing one component from another component. These terms do not limit the difference in the material or structure of the components.

The terms of a singular form may include plural forms unless otherwise specified. In addition, when a certain part “includes” a certain component, it means that other components may be further included rather than excluding other components unless otherwise stated.

In addition, terms such as “unit” and “module” described in the specification may indicate a unit that processes at least one function or operation, and this may be implemented as hardware or software, or may be implemented as a combination of hardware and software.

The use of the term “the” and similar designating terms may correspond to both the singular and the plural.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

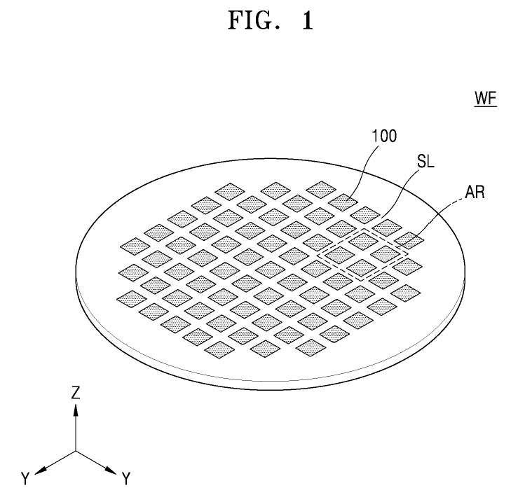

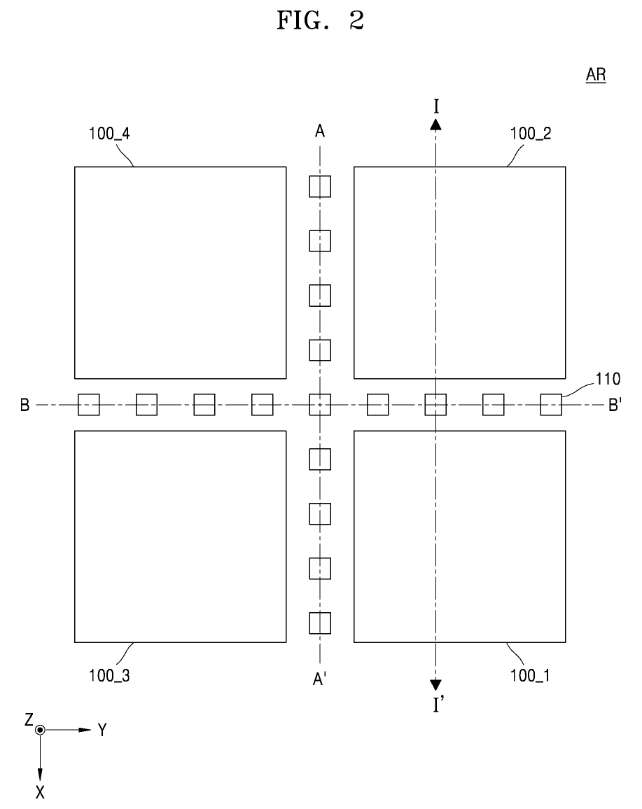

FIG. 1 is a perspective view schematically illustrating a wafer WF according to an embodiment. FIG. 2 is a plan view illustrating an enlarged portion of the wafer WF according to an embodiment.

Hereinafter, unless specially defined, a direction perpendicular to the wafer WF may be defined as a vertical direction (a Z direction), a direction perpendicular to the vertical direction may be defined as a first horizontal direction (an X direction), and a direction perpendicular to the vertical direction and the first horizontal direction may be defined as a second horizontal direction (a Y direction). In some embodiments, an X direction may be referred to as a first direction, a Y direction may be referred to as a second direction, and a Z direction may be referred to as a third direction.

Referring to FIG. 1, a plurality of semiconductor chips 100 arranged in a matrix form may be formed in the wafer WF. In some embodiments, a semiconductor chip may be referred to as a semiconductor device. A region where the plurality of semiconductor chips 100 are disposed may be referred to as a chip region.

In an embodiment, the plurality of semiconductor chips 100 may each be a memory chip or a logic chip. The memory chip may include, for example, dynamic random access memory (DRAM), static random access memory (SRAM), flash memory, electrically erasable programmable read-only memory (EEPROM), phase-change random access memory (PRAM), magnetoresistive random access memory (MRAM), or resistive random access memory (RRAM). The logic chip may include, for example, a microprocessor such as a central processing unit (CPU), a graphics processing unit (GPU), a neural processing unit (NPU), or an application processor (AP), an analog device, or a digital signal processor.

A scribe lane region SL may be defined between the plurality of semiconductor chips 100. The scribe lane region SL may provide a path for isolating (singulation) the wafer WF into a plurality of individual chips in a dicing process. That is, semiconductor process equipment may dice the wafer WF by using a blade or a laser while moving along the scribe lane region SL. Herein, a singulation path disposed in the scribe lane region SL may be referred to as a singulation-expected line.

In an embodiment, the semiconductor process equipment may dice the wafer WF by using only the blade in the dicing process.

In an embodiment, the semiconductor process equipment may dice the wafer WF by using the blade and the laser in the dicing process.

In an embodiment, the semiconductor process equipment may dice the wafer WF by using only the laser in the dicing process.

The scribe lane region SL may be a region which is not finally included in an individual semiconductor chip. Therefore, various structures for testing the wafer WF by using the scribe lane region SL may be disposed. A test may be mainly performed in a semiconductor back-end process, and such a test may denote a process which minimizes loss by preventing a defect occurring in a semiconductor chip from being transferred to a subsequent process, based on inspection of electrical characteristics.

In an embodiment, a plurality of test element groups (TEGs) (110 of FIG. 2) for evaluating an electrical characteristic of an individual element or monitoring the quality of a semiconductor manufacturing process may be formed in the scribe lane region SL. The plurality of TEGs 110 may be generally formed by using a wiring pattern including a metal material and may be used to analyze a correlation between an electrical parameter and a process variable.

In an embodiment, each of the plurality of TEGs 110 may be configured with various elements such as a transistor, a capacitor, a resistor, and a diode.

Furthermore, a crack may occur in the wafer WF during a dicing process of dicing the wafer WF along the scribe lane region SL. Particularly, a lateral crack, which horizontally propagates from a cut surface to the inside of a wafer substrate (for example, in an X or Y direction), may occur and may adversely affect the reliability of an adjacent semiconductor chip. Herein, unless specially described, a "crack" or a "defect" may denote a lateral crack, but is not limited thereto.

The plurality of TEGs 110 may be disposed in the scribe lane region SL, and particularly, may be disposed in a singulation-expected line or near thereto, and thus, the plurality of TEGs 110 may be diced together when performing a dicing process. The presence of the plurality of TEGs 110 may affect a crack occurrence form when performing a dicing process.

For example, in a dicing process using a blade, mechanical stress based on the blade may interact with a TEG which includes metal and is relatively hard, causing stress concentration. Due to this, the possibility that a lateral crack occurs in a lower region of a TEG may increase.

On the other hand, in a dicing process using a laser, thermal energy generated by laser irradiation may be a main factor of a dicing mechanism. A TEG including a metal material may have a good thermal conduction characteristic. Therefore, in laser irradiation, a TEG may effectively absorb incident laser energy and may quickly transfer (discharge) the laser energy to the periphery thereof. Accordingly, local thermal stress concentration may be alleviated in a lower region of a TEG, and thus, the occurrence of a lateral crack in a corresponding region may be prevented. On the other hand, in a dicing process using a laser, the possibility that a crack occurs may be relatively high in a lower region of a scribe lane region SL where a TEG is not provided. Hereinafter, a case which primarily performs dicing with a laser and uses a blade for secondarily dicing a residual region will be described for example, but this is for description and embodiments are not limited thereto.

Referring to FIG. 2, the plurality of semiconductor chips 100 may include first to fourth semiconductor chips 100_1 to 100_4. A region AR may correspond to a portion of the wafer WF of FIG. 1 and may include the first to fourth semiconductor chips 100_1 to 100_4.

Line A-A' and line B-B' may each be a singulation-expected line. That is, when dicing the wafer WF, each of the first to fourth semiconductor chips 100_1 to 100_4 may be diced along line A-A' and line B-B'.

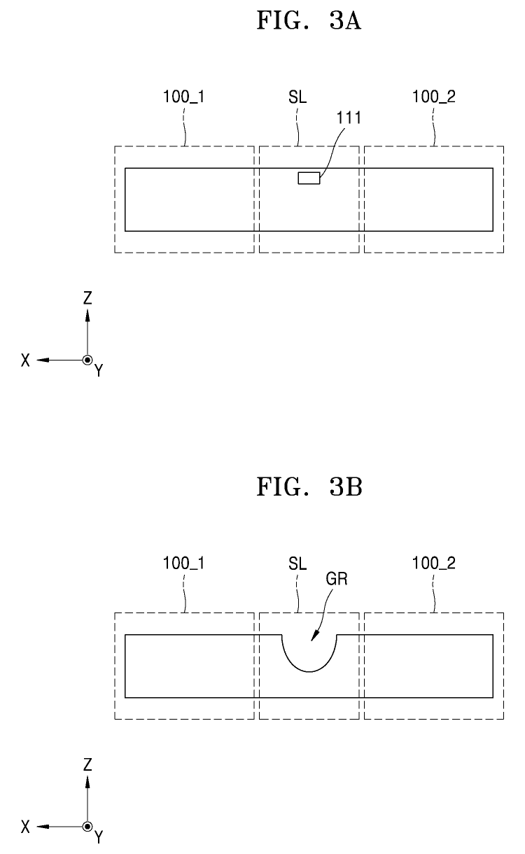

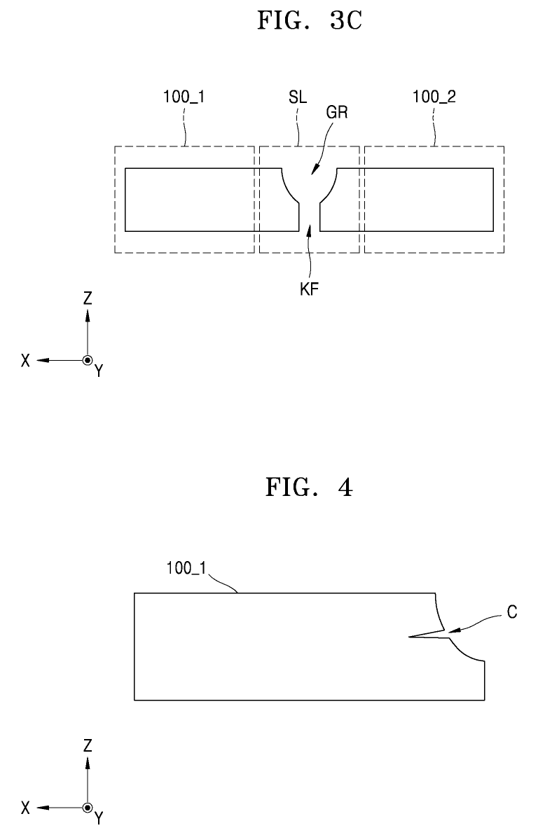

FIGS. 3A to 3C are cross-sectional views illustrating a cross-sectional surface of a portion of a wafer WF according to an embodiment. In detail, FIGS. 3A to 3C are cross-sectional views illustrating the region AR of FIG. 2 along line I-I’. FIGS. 3A to 3C may be described with reference to FIGS. 1 and 2, and repeated descriptions may be omitted.

Referring to FIG. 3A, a first semiconductor chip 100_1, a scribe lane region SL, and a second semiconductor chip 200_2 may be illustrated in a cross-sectional view taken along line I-I’. FIG. 3A illustrates a state before a dicing process on a wafer WF is performed. In an embodiment, the scribe lane region SL may include a TEG 111. The TEG 111 of FIG. 3A may correspond to at least one of the plurality of TEGs 110 illustrated in FIG. 2.

Referring to FIG. 3B, FIG. 3B illustrates a state where a portion of a dicing process has been performed on the wafer WF. In an embodiment, the dicing process may include a primary dicing operation using a laser. A portion of the wafer WF may be removed by emitting a laser along the scribe lane region SL, and thus, a groove GR may be formed. In a process of forming the groove GR, the TEG 111 disposed in a singulation-expected line may be removed.

FIG. 3C illustrates a state where an additional operation of the dicing process has been performed after the state of FIG. 3B. In an embodiment, the dicing process may include a secondary dicing operation using a blade. The wafer WF may be completely diced along the groove GR formed in the scribe lane region SL by using the blade, and thus, the first semiconductor chip 100_1 and the second semiconductor chip 100_2 may be isolated from each other. A kerf KF may be formed between the first semiconductor chip 100_1 and the second semiconductor chip 100_2 isolated from each other. In some embodiments, the groove GR may be referred to as a first groove, and the kerf KF may be referred to as a second groove. Herein, the groove GR may denote a V-shape or a U-shape, which is formed in a scribe lane by using a laser, and the kerf KF may denote a space which is formed between adjacent chips as a wafer is completely isolated (e.g., separated) through dicing based on a blade after the groove GR is formed.

In an embodiment, the secondary dicing operation of FIG. 3C may be performed by a laser instead of a blade.

FIG. 4 is a diagram illustrating a crack occurring in a wafer WF according to an embodiment. In detail, FIG. 4 may illustrate a partial cross-sectional surface of a first semiconductor chip 100_1 isolated after a dicing process.

Referring to FIG. 4, a shape is illustrated where a crack C propagates toward the inside of a chip from a cut surface (i.e., a side surface of a chip adjacent to the groove GR and the kerf KF described above with reference to FIG. 3C) formed by a dicing process. In FIG. 4, it may be assumed that the crack C occurs in the first semiconductor chip 100_1, but embodiments are not limited thereto. That is, the crack C may occur in a second semiconductor chip 100_2, and depending on the case, the crack C may occur in both of the first semiconductor chip 100_1 and the second semiconductor chip 100_2, or the crack C may not occur in both of the first semiconductor chip 100_1 and the second semiconductor chip 100_2.

Particularly, the crack C may be referred to as a lateral crack which propagates a direction substantially parallel to a wafer surface. The crack C occurring in the first semiconductor chip 100_1 may cause a serious problem in performance and reliability of a semiconductor device, but there may be a problem where it is difficult to observe from the outside.

Herein, a defect occurring in a semiconductor chip or the wafer WF may denote the crack C.

According to an embodiment, a defect occurring in the wafer WF may be detected by effectively determining whether there is the crack C, based on image analysis, and thus, a semiconductor chip having a defect may be screened.

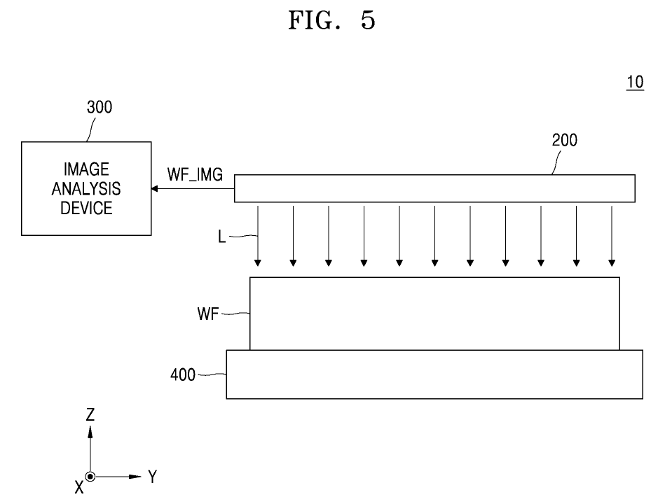

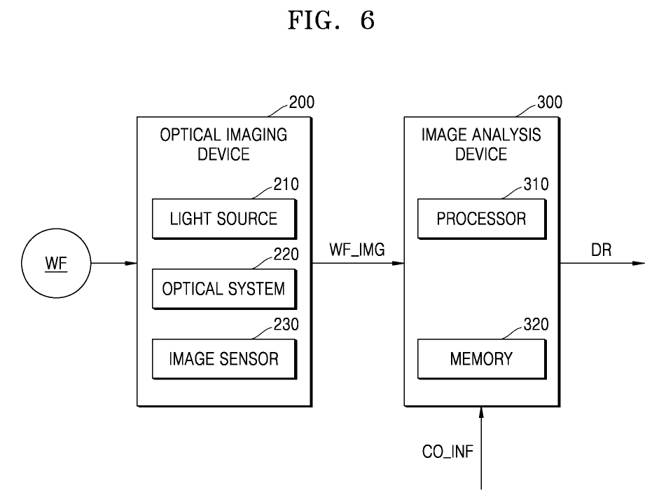

FIG. 5 is a block diagram illustrating a defect detection device 10 for detecting a defect of a semiconductor device, according to an embodiment. FIG. 6 is a block diagram illustrating configurations of an optical imaging device 200 and an image analysis device 300, according to an embodiment. FIGS. 5 and 6 may be described with reference to FIGS. 1 to 4, and repeated descriptions may be omitted.

Referring to FIGS. 5 and 6, the defect detection device 10 may include the optical imaging device 200, the image analysis device 300, and a stage 400. In some embodiments, the defect detection device 10 may be simply referred to as a system. Also, the defect detection device 10 may be referred to as a crack detection device, a crack detection system, a detection system, an optical inspection device, or an optical inspection system.

A wafer WF may be loaded onto or unloaded from the stage 400. In an embodiment, an example where it is assumed that the wafer WF is loaded onto the stage 400 may be described below, but embodiments are not limited thereto. A portion of the wafer WF instead of the entire wafer WF may be loaded onto the stage 400, and for example, at least one of a plurality of semiconductor chips 100 may be loaded.

In an embodiment, the defect detection device 10 may be semiconductor process equipment for semiconductor dicing. The defect detection device 10 may emit light L onto a semiconductor chip or the wafer WF loaded onto the stage 400 after a semiconductor dicing process is performed, and thus, a crack occurring in the wafer WF or the semiconductor chip may be detected.

The optical imaging device 200 may include a light source 210 which emits the light L, an optical system 220 which controls a path of the light L, and an image sensor 230 which senses reflected light to form an image. The optical imaging device 200 may be configured to emit the light L onto the wafer WF loaded onto the stage 400, and moreover, may be configured to receive the light L reflected from the wafer WF. The optical imaging device 200 may detect the crack C occurring in the wafer WF, based on the received light L.

The light source 210 may be configured to generate the light L. The light source 210 may adjust an intensity, a wavelength, and an emission angle of the light L and may be configured to emit the light L onto a certain position. In some embodiments, the light source 210 may be referred to as a light-emitting unit.

According to embodiments, the light L emitted toward the wafer WF from the light source 210 may include red visible light. The light L may have a wavelength within a range of about 620 nm to about 750 nm. When the light L includes red visible light, as described below, the crack C occurring in the wafer WF may be detected without replacing semiconductor manufacturing facilities. Also, when the light L includes red visible light, the crack C in the wafer WF may be more accurately and easily detected. However, the kind and wavelength of the light L are not limited thereto, and the light L may include infrared light, and a wavelength of the light L may be within a range of about 620 nm to about 1 mm.

The optical system 220 may be configured to control a path of the light L. The optical system 220 may be configured to concentrate the light L in a certain region to secure an image of high resolution. The optical system 220 may include a condensing lens, a diffusion lens, and a mirror.

The image sensor 230 may generate an image through a complementary metal-oxide-semiconductor (CMOS) or charge-coupled device (CCD) sensor, based on the light L reflected from a semiconductor chip. The image sensor 230 may obtain a clear image where noise is minimized through an optical filter.

The optical imaging device 200 may generate an inspection image WF_IMG through the image sensor 230. The optical imaging device 200 may provide the inspection image WF_IMG to the image analysis device 300.

In an embodiment, the inspection image WF_IMG may be an auto visual inspection (AVI) image or an external visual inspection (EVI) image.

The image analysis device 300 may include a processor 310 and a memory 320. The image analysis device 300 may be configured to detect whether the crack C occurs in the wafer WF, based on the inspection image WF_IMG obtained from the image sensor 230 and position information CO_INF obtained from the outside. In some embodiments, the image analysis device 300 may be included in the optical imaging device 200.

The processor 310 may perform a function of determining whether there is a crack C occurring in the wafer WF, based on the inspection image WF_IMG and the position information CO_INF. For example, the processor 310 may be various types of operational devices such as a CPU, a GPU, an NPU, or a tensor processing unit (TPU) specialized for an artificial intelligence (AI) operation. The processor 310 may be implemented with a hardware circuit, or may be a general-purpose computing device which executes a software program instruction.

The inspection image WF_IMG obtained from the image sensor 230 and the position information CO_INF obtained from the outside (i.e., predetermined position information supplied to the system from an outside source, such as a user input, another computer system, a separate memory etc.) may be stored in the memory 320. Also, the memory 320 may store instructions which allow the processor 310 to perform an operation of detecting a defect (for example, a lateral crack) occurring in the wafer WF or a semiconductor chip.

In an embodiment, the memory 320 may be a volatile or non-volatile storage device, and for example, may include a volatile memory, such as DRAM or SRAM, or a non-volatile memory such as flash memory, EEPROM, PRAM, MRAM, or RRAM.

The position information CO_INF may be a data set including values respectively representing positions of the plurality of TEGs 110 formed on the wafer WF. The spatial placement of each of the plurality of TEGs 110 on the wafer WF may be defined through the position information CO_INF. The position information CO_INF may be a value which is previously input to the image analysis device 300, or may be a value which is received from the outside.

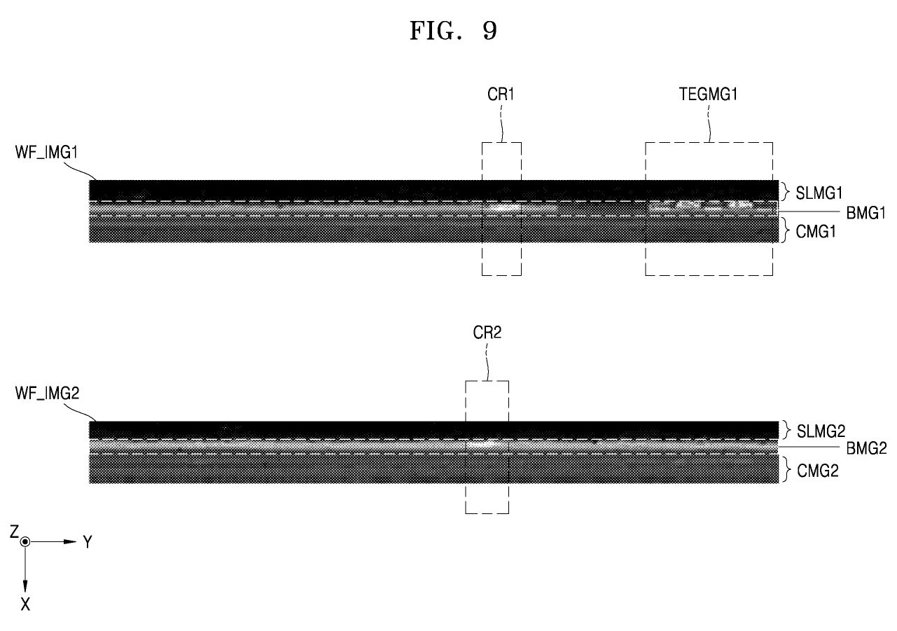

The image analysis device 300 may distinguish an inspection-targeted region and a masking region from the inspection image WF_IMG by using the position information CO_INF. The inspection-targeted region and the masking region will be described below in detail with reference to FIG. 9.

The image analysis device 300 may output an analysis result DR based on a result obtained by analyzing the inspection image WF_IMG.

In an embodiment, when a defect is detected as a result of analysis of the inspection image WF_IMG, the analysis result DR may have a value (for example, a first value) representing that a defect is in the inspection image WF_IMG.

In an embodiment, when a defect is detected as a result of analysis of the inspection image WF_IMG, the analysis result DR may have a value (for example, a first value) representing that there is no defect in the inspection image WF_IMG.

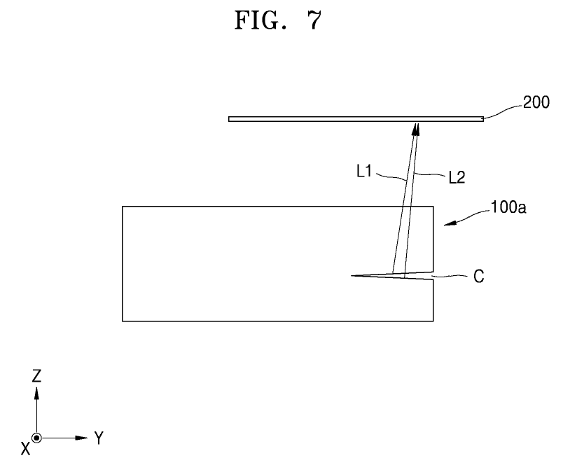

FIG. 7 is a diagram illustrating an example where an optical imaging device 200 emits light L and receives reflected light L according to an embodiment. FIG. 7 may be described with reference to FIGS. 5 and 6, and repeated descriptions may be omitted.

Referring to FIG. 7, a semiconductor chip 100a of FIG. 7 may correspond to one of the plurality of semiconductor chips 100 of FIG. 1. The light L emitted from the optical image device 200 may pass through the inside of the semiconductor chip 100a and may travel, and then, may be reflected by some elements of the semiconductor chip 100a and may be received by the optical image device 200. At this time, when a crack C is in the semiconductor chip 100a, first light L1 and second light L2 may be received by the optical imaging device 200. In this case, the first light L1 may be light which is directly reflected from a surface of the crack C, and the second light L2 may be light which enters the inside of the crack C and is reflected from another surface of the crack C. Therefore, the first light L1 and the second light L2 may have a phase difference therebetween and may overlap each other.

The image sensor 230 may generate an image based on the phase difference between the first light L1 and the second light L2. Due to the phase difference between the first light L1 and the second light L2, a portion of an inspection image WF_IMG corresponding to the crack C may be seen brighter than the other portions of the inspection image WF_IMG.

In an embodiment, a fringe caused by the phase difference between the first light L1 and the second light L2 may appear in the inspection image WF_IMG.

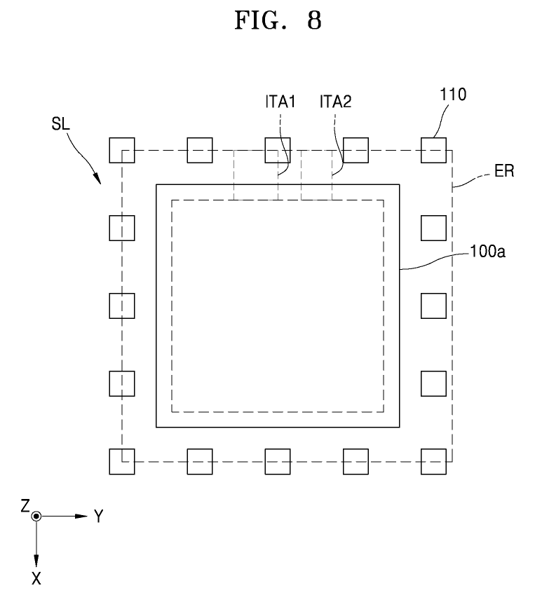

FIG. 8 is a diagram illustrating an inspection-targeted region of a wafer WF imaged by an optical imaging device 200 according to an embodiment. FIG. 8 may be described with reference to FIGS. 1 to 7, and repeated descriptions may be omitted.

Referring to FIG. 8, a plurality of TEGs 110 may be disposed in a scribe lane region SL adjacent to a semiconductor chip 100a of FIG. 8. The semiconductor chip 100a may correspond to one of the plurality of semiconductor chips 100 of FIG. 1.

An inspection image WF_IMG may be an image corresponding to an inspection-targeted region which is a portion of an edge region ER of the semiconductor chip 100a. Herein, the inspection-targeted region may denote a region which is an analysis target for determining whether a defect is in a region of the wafer WF, so as to determine whether a crack C occurs.

The edge region ER may include a plurality of inspection-targeted regions. In an embodiment, the plurality of inspection-targeted regions may include a first inspection-targeted region ITA1 and a second inspection-targeted region ITA2.

Each of the inspection-targeted regions may include at least a portion of the scribe lane region SL and at least a portion of the semiconductor chip 100a. For example, as illustrated in FIG. 8, each of the first inspection-targeted region ITA1 and the second inspection-targeted region ITA2 may include at least a portion of the scribe lane region SL and at least a portion of the semiconductor chip 100a.

In an embodiment, the inspection-targeted region may include at least one of the plurality of TEGs 110 or not. For example, as illustrated in FIG. 8, the first inspection-targeted region ITA1 may include one of the plurality of TEGs 110, and the second inspection-targeted region ITA2 may not include any one of the plurality of TEGs 110.

In an embodiment, the inspection image WF_IMG may be a portion which corresponds to an inspection-targeted region and is extracted from all or some images obtained by emitting light L onto the wafer WF.

In an embodiment, the inspection image WF_IMG may be an image which is obtained by emitting the light L onto the inspection-targeted regions of the wafer WF.

FIG. 9 is a diagram illustrating an inspection image according to an embodiment. FIG. 9 may be described with reference to FIGS. 1 to 8, and repeated descriptions may be omitted.

Referring to FIG. 9, as an example of an inspection image WF_IMG, a first inspection image WF_IMG1 and a second inspection image WF_IMG2 are illustrated in FIG. 9.

The first inspection image WF_IMG1 may be obtained by imaging the first inspection-targeted region ITA1 of FIG. 8 through the optical imaging device 200. The second inspection image WF_IMG2 may be obtained by imaging the second inspection-targeted region ITA2 of FIG. 8 through the optical imaging device 200.

The inspection image WF_IMG may be divided into a scribe lane image region, corresponding to a scribe lane region SL formed in the wafer WF, and a chip image region and a boundary region each corresponding to a semiconductor chip 100a. Herein, the boundary region may denote a region disposed between the scribe lane image region and the chip image region. Also, the inspection image WF_IMG may be divided into a brightly displayed region and a darkly displayed region. In this case, a region which is included in the boundary region of the inspection image WF_IMG and a region representing relatively high brightness may each be regions representing high brightness, based on a TEG or a crack C.

In an embodiment, the first inspection image WF_IMG1 may include a first scribe lane image region SLMG1, a first chip image region CMG1, and a first boundary region BMG1. The first boundary region BMG1 may be a region representing a boundary between the first scribe lane image region SLMG1 and the first chip image region CMG1. A first TEG image region TEGMG1 corresponding to a portion of a TEG included in the first inspection-targeted region ITA1 may be included in the inspection image WF_IMG. Also, a first crack region CR1 may be included in the first inspection image WF_IMG1. The first TEG image region TEGMG1 may be a region which appears bright in the first inspection image WF_IMG1, based on a portion of the TEG included in the first inspection-targeted region ITA1, and the first crack region CR1 may be a region which appears bright in the first inspection image WF_IMG1 because a crack occurs in the first inspection-targeted region ITA1. Herein, appearing bright may refer to aspects of the image that are brighter than other aspects in the image.

In an embodiment, the second inspection image WF_IMG2 may include a second scribe lane image region SLMG2, a second chip image region CMG2, and a second boundary region BMG2. The second boundary region BMG2 may be a region representing a boundary between the second scribe lane image region SLMG2 and the second chip image region CMG2. A second crack region CR2 may be included in the second inspection image WF_IMG2. The second crack region CR2 may be a region which appears bright in the second inspection image WF_IMG2 because a crack occurs in the second inspection-targeted region ITA2.

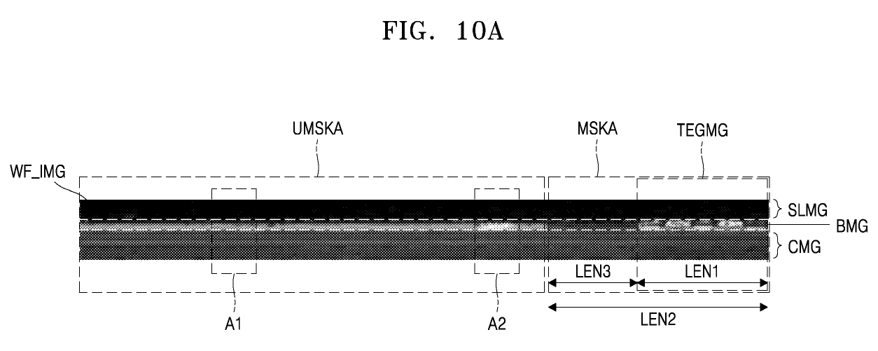

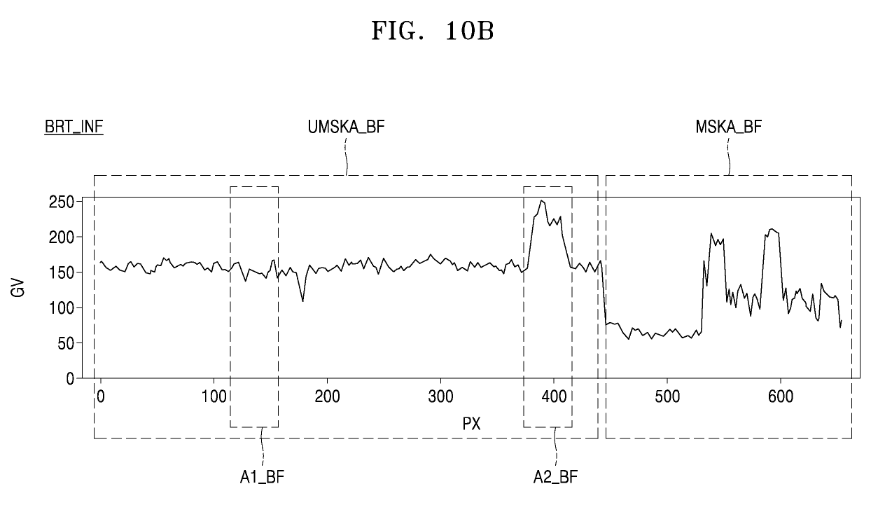

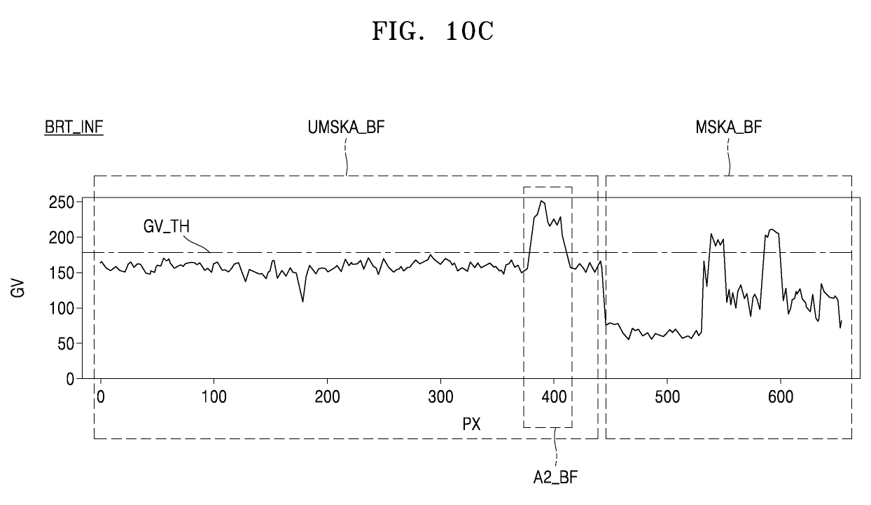

FIGS. 10A to 10C are diagrams illustrating a method of detecting a defect of a semiconductor chip, according to an embodiment. In detail, FIG. 10A is a diagram illustrating an example where an inspection image WF_IMG is divided into a masking region MSKA and a non-masking region UMSKA. FIGS. 10B and 10C are diagrams illustrating an example where an image analysis device 300 detects a defect region based on brightness information BRT_INF. FIGS. 10A to 10C may refer to FIGS. 1 to 9, and repeated descriptions may be omitted.

Referring to FIG. 10A, the inspection image WF_IMG of FIG. 10A may correspond to the first inspection image WF_IMG1 of FIG. 9. The inspection image WF_IMG may include a scribe lane image region SMG, a chip image region CMG, and a boundary region BMG. The scribe lane image region SMG may correspond to the first scribe lane image region SLMG1. The chip image region CMG may correspond to the first chip image region CMG1. The boundary region BMG may correspond to the first boundary region BMG1. In the inspection image WF_IMG, a first region A1 may correspond to a portion or all of a region, where a crack does not occur, of the non-masking region UMSKA, and a second region A2 may correspond to a portion or all of a region, where a crack does occur, of the non-masking region UMSKA. The first region A1 may be referred to as a normal region, and the second region A2 may be referred to as a defect region.

Referring to FIGS. 10B and 10C, brightness information BRT_INF may be information representing brightness of pixels configuring the boundary region BMG of the inspection image WF_IMG, and in this case, the information representing brightness may denote, for example, a gray value (GV). The brightness information BRT_INF may express gray values of the pixels corresponding to the boundary region BMG in the form of arrangement, histogram, or graph.

In an embodiment, as illustrated in FIGS. 10B and 10C, the brightness information BRT_INF may be expressed as a graph, and the abscissa axis of the graph may represent a position of a pixel, and the ordinate axis may have a gray value.

In an embodiment, the inspection image WF_IMG may be stored in a grayscale form of 8 bits, and in this case, one pixel may have an integer value between 0 and 255. As a value approaches 0, the value may correspond to complete black because pixel brightness is dark, and as a value approaches 255, the value may correspond to complete white because pixel brightness is bright. Therefore, when a gray value difference between two pixels increases, this may denote that the intensity difference of reflected light on a wafer is actually large.

In an embodiment, a pixel may have a higher bit such as 10 bits or 12 bits. Herein, for convenience of description, an 8-bit gray value may be described for example, but the inventive concept is not limited thereto.

Referring again to FIG. 10A, the inspection image WF_IMG may be divided into a masking region MSKA and a non-masking region UMSKA. The masking region MSKA may be a region including a TEG image region TEGMG which appears in the inspection image WF_IMG. The TEG image region TEGMG may correspond to the first TEG image region TEGMG1 of FIG. 9. The non-masking region UMSKA may denote the other region, except the masking region MSKA, of the inspection image WF_IMG.

In a case where a laser is used when dicing the wafer WF, because there is a TEG, the probability that a lateral crack occurs in a lower portion of the TEG may be low. However, the TEG image region TEGMG may also appear with brightness in the inspection image WF_IMG, and due to this, it may be difficult to determine whether there is a crack based on the inspection image WF_IMG. Therefore, it may be needed to exclude the TEG image region TEGMG from an analysis target of the image analysis device 300.

The image analysis device 300 may detect a position of a TEG, based on previously obtained position information CO_INF, and may identify the masking region MSKA and the non-masking region UMSKA from the inspection image WF_IMG, based on the detected position, such that these regions may be distinguished. That is, in some embodiments, since there is varied brightnesses occurring in the TEG image region TEGMG due to the various components present, these brightnesses may adversely affect the image analysis for detecting high brightnesses corresponding to cracks, and thus, the system may be configured to exclude the TEG image region TEGMG from the brightness evaluation. When performing a defect detection operation, the masking region MSKA may be excluded from an analysis target, and the image analysis device 300 may perform analysis on only the non-masking region UMSKA.

In an embodiment, a length of the masking region MSKA in a second horizontal direction may be longer than that of the TEG image region TEGMG in the second horizontal direction. For example, a length of the TEG image region TEGMG in the second horizontal direction may be a first length LEN1, and a length of the masking region MSKA in the second horizontal direction may be a second length LEN2. In this case, the second length LEN2 may be longer than the first length LEN1.

In an embodiment, a third length LEN3 corresponding to a difference between the second length LEN2 and the first length LEN1 may be a value which is set to have a predetermined value and is stored in the image analysis device 300. In some embodiments, the third length LEN3 may be referred to as a predetermined margin length. As described above, the margin length may be set based on that the probability that a crack occurs near a TEG is low because the TEG absorbs heat when performing dicing using a laser.

Hereinafter, for convenience of description, a difference between an average gray value of an entire non-masking region UMSKA and a first average gray value which is an average gray value of the first region A1 may be assumed to be less than a defect reference gray value, and a difference between the average gray value of the entire non-masking region UMSKA and a second average gray value which is an average gray value of the second region A2 may be assumed to be greater than the defect reference gray value, and based thereon, description will be given below. In this case, the defect reference gray value may be a value which is previously set and is stored in the image analysis device 300.

Referring to FIGS. 10B and 10C, the image analysis device 300 may analyze brightness information BRT_INF corresponding to a boundary region BMG of an inspection image WF_IMG, and thus, may detect a defect region. The image analysis device 300 may exclude masking region brightness information MSKA_BF, corresponding to the masking region MKSA in the brightness information BRT_INF, from an analysis target. The image analysis device 300 may analyze non-masking region brightness information UMSKA_BF which is brightness information corresponding to the non-masking region UMKSA, and thus, may detect a defect region from the non-masking region UMKSA.

In FIGS. 10B and 10C, first region brightness information A1_BF may correspond to brightness information about the first region A1. Second region brightness information A2_BF may correspond to brightness information about the second region A2. In this case, an average of gray values of the first region brightness information A1_BF may be a first average gray value, and an average of gray values of the second region brightness information A2_BF may be a second average gray value. In this case, the second average gray value may be greater than the first average gray value.

Referring to FIG. 10B, the image analysis device 300 may detect, as a defect region, a region having relatively high brightness in the non-masking region UMKSA.

In an embodiment, the image analysis device 300 may divide the non-masking region UMKSA into a plurality of regions and may determine average gray values respectively corresponding to the plurality of regions from the brightness information BRT_INF. In this case, the first region A1 and the second region A2 may be included in the plurality of regions. The image analysis device 300 may compare average gray values of regions with the average gray value of the entire non-masking region UMKSA. The image analysis device 300 may determine, as a defect region, a region having an average gray value which is the defect reference gray value greater than the average gray value of the entire non-masking region UMKSA. For example, because a difference between the first average gray value and the average gray value of the entire non-masking region UMKSA is less than the defect reference gray value, the image analysis device 300 may determine the first region A1 as a normal region (e.g., a region without a defect/crack). Also, for example, because a difference between the second average gray value and the average gray value of the entire non-masking region UMKSA is greater than the defect reference gray value, the image analysis device 300 may detect the second region A2 as a defect region.

In an embodiment, the image analysis device 300 may select a pixel having the brightest gray value from the brightness information BRT_INF, may set, as the second region A2, a region having a predetermined defect determination length from the selected pixel, and may compare an average gray value of the second region A2 with the average gray value of the entire non-masking region UMKSA. In this case, the predetermined defect determination length may be a value which is previously set and is stored in the image analysis device 300. Because the difference between the second average gray value and the average gray value of the entire non-masking region UMKSA is greater than the defect reference gray value, the image analysis device 300 may detect the second region A2 as a defect region. Put alternatively, the image analysis device 300 may determine that a defect region corresponds to a sequence or series of consecutive gray values that are greater than a defect reference gray value or that are greater than the average gray value of the entire non-masking region UMKSA.

Referring to FIG. 10C, the image analysis device 300 may detect, as a defect region, a region where a gray value thereof is greater than a threshold gray value GV_TH in the non-masking region UMKSA.

In an embodiment, a gray value corresponding to the second region brightness information A2_BF may be greater than the threshold gray value GV_TH in the non-masking region UMKSA, and thus, the image analysis device 300 may detect the second region A2 as a defect region. A gray value corresponding to the other region except the second region A2 in the non-masking region UMKSA may be less than the threshold gray value GV_TH, and thus, the image analysis device 300 may determine, as a normal region, the other region except the second region A2.

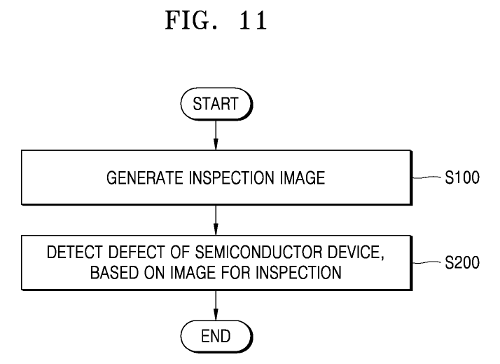

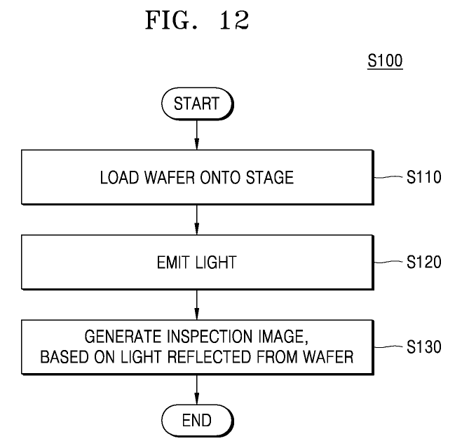

FIG. 11 is a diagram illustrating a method of detecting a defect of a semiconductor device, according to an embodiment. FIG. 11 may be described with reference to FIGS. 1 to 10, and repeated descriptions may be omitted.

Referring to FIG. 11, in operation S100, the defect detection device 10 may emit light onto a wafer WF by using the optical imaging device 200, and thus, may generate an inspection image WF_IMG corresponding to the wafer WF. Operation S100 will be described below in detail with reference to FIG. 12.

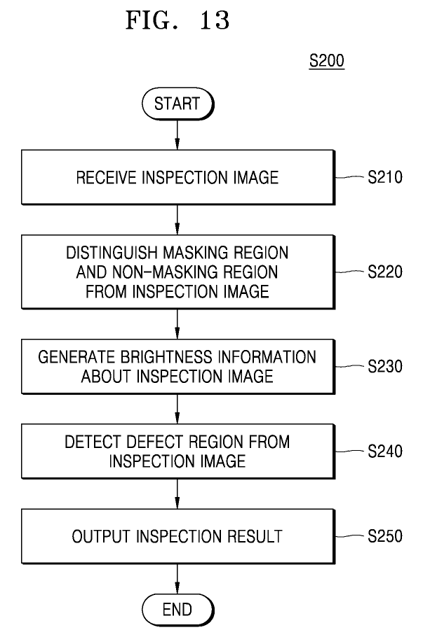

In operation S200, the defect detection device 10 may detect a defect occurring in a semiconductor device included in the wafer WF, based on the inspection image WF_IMG. In detail, the defect detection device 10 may analyze the inspection image WF_IMG by using the image analysis device 300, and thus, may detect a defect occurring in the wafer WF or the semiconductor device included in the wafer WF. Operation S200 will be described below in detail with reference to FIG. 13.

FIG. 12 is a flowchart illustrating a method of detecting a defect of a semiconductor device, according to an embodiment. In detail, FIG. 12 may be described as a subdivision of operation S100 of FIG. 11. FIG. 12 may be described with reference to FIGS. 1 to 11, and repeated descriptions may be omitted.

Referring to FIG. 12, in operation S110, the wafer WF may be loaded onto the stage 400 of the defect detection device 10.

In an embodiment, a portion (for example, at least one of a plurality of semiconductor chips configuring the wafer WF) or all of the wafer WF may be loaded onto the stage 400 of the defect detection device 10.

In operation S120, the defect detection device 10 may emit light L onto the wafer WF.

In an embodiment, the light L emitted by the defect detection device 10 may include red visible light, and in this case, the light L may have a wavelength within a range of about 620 nm to about 750 nm.

In an embodiment, the light L emitted by the defect detection device 10 may include infrared light, and in this case, the light L may have a wavelength within a range of about 620 nm to about 1 mm.

In operation S130, the defect detection device 10 may generate an inspection image WF_IMG based on light reflected from the wafer WF.

In an embodiment, the inspection image WF_IMG may be an image representing all or a portion of the wafer WF.

FIG. 13 is a flowchart illustrating a method of detecting a defect of a semiconductor device, according to an embodiment. In detail, FIG. 11 may be described as a subdivision of operation S200 of FIG. 11. FIG. 13 may be described with reference to FIGS. 1 to 12, and repeated descriptions may be omitted.

Referring to FIG. 13, in operation S210, the defect detection device 10 may provide the image analysis device 300 with the inspection image WF_IMG generated by the optical imaging device 200. In other words, the image analysis device 300 may receive the inspection image WF_IMG from the optical imaging device 200.

In operation S220, the defect detection device 10 may identify a non-masking region UMSKA from the inspection image WF_IMG.

In an embodiment, the defect detection device 10 may divide the inspection image WF_IMG into a masking region MSKA and the non-masking region UMSKA, based on position information CO_INF.

In an embodiment, the masking region MSKA may include a TEG image TEGMG. The TEG image TEGMG may be an image corresponding to at least one of a plurality of TEGs which are on the wafer WF.

In operation S230, the defect detection device 10 may generate brightness information BRT_INF corresponding to the inspection image WF_IMG.

In an embodiment, the brightness information BRT_INF may be information representing brightness of pixels corresponding to a boundary region BMG in the inspection image WF_IMG. In this case, brightness of each pixel may be expressed by a gray value. A gray value of each pixel configuring the boundary region BMG may have a value of 8 bits.

In an embodiment, operation S230 may be performed prior to operation S220.

In operation S240, the defect detection device 10 may detect a defect region from the inspection image WF_IMG. The defect detection device 10 may exclude a region, included in the masking region MSKA in the inspection image WF_IMG, from an analysis target. That is, the defect detection device 10 may analyze whether a defect is in only a region included in the non-masking region UMSKA in the inspection image WF_IMG, and thus, may detect a defect region.

In an embodiment, the defect detection device 10 may divide the non-masking region UMKSA into a plurality of regions and may determine average gray values respectively corresponding to the plurality of regions from the brightness information BRT_INF. The defect detection device 10 may compare average gray values of regions with an average gray value of the entire non-masking region UMKSA. The defect detection device 10 may determine, as a defect region, a region having an average gray value which is the defect reference gray value or more greater than the average gray value of the entire non-masking region UMKSA.

In an embodiment, the defect detection device 10 may select a pixel having the brightest gray value from the brightness information BRT_INF and may compare an average gray value of a region, having a predetermined defect determination length from the selected pixel, with the average gray value of the entire non-masking region UMKSA. When a difference between an average gray value of a selected region and the average gray value of the entire non-masking region UMKSA is greater than a defect reference gray value, the defect detection device 10 may detect the selected region as a defect region.

In operation S250, the defect detection device 10 may output an inspection result DR based on an operation of operation S240.

In an embodiment, when a defect region is detected as a result obtained by performing the operation of operation S240, the defect detection device 10 may output the inspection result DR representing that a semiconductor chip corresponding to the inspection image WF_IMG has a defect. Accordingly, the semiconductor chip having the defect may be screened.

In an embodiment, when a defect region is detected as a result obtained by performing the operation of operation S240, the defect detection device 10 may output the inspection result DR representing that the semiconductor chip corresponding to the inspection image WF_IMG has no defect.

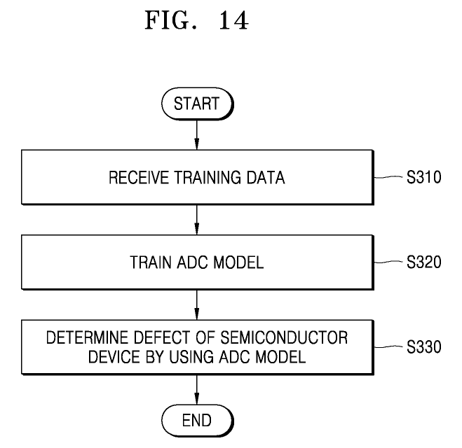

FIG. 14 is a flowchart illustrating construction of an analog-to-digital conversion (ADC) model according to an embodiment. FIG. 14 may be described with reference to FIG. 13, and repeated descriptions may be omitted.

Referring to FIG. 14, an inspection result generated through operation S200 may be used as training data training an ADC model. The ADC model may denote an image-based wafer inspection model. The ADC model may be implemented with a neural network.

In an embodiment, the neural network may include various kinds of neural network models such as GoogleNet, AlexNet, convolution neural network (CNN) such as VGG network, region with convolution neural network (R-CNN), region proposal network (RPN), recurrent neural network (RNN), stacking-based deep neural network (S-DNN), state-space dynamic neural network (S-SDNN), deconvolution network, deep belief network (DBN), restricted Boltzmann machine (RBM), fully convolutional network, long short-term memory (LSTM) network, and classification network, but is not limited thereto.

In an embodiment, the ADC model may be stored in the image analysis device 300, or may be stored in a deep learning system which is provided separately from the image analysis device 300. Hereinafter, it may be assumed that the ADC model is stored in a deep learning system, and based thereon, an operation of the deep learning system will be described, but this may be for description and does not limit the inventive concept.

In operation S310, the deep learning system may receive training data from the outside. The training data may include the inspection image WF_IMG and an inspection result DR based on operation S250. For example, the inspection result DR may include the inspection image WF_IMG and a defect analysis result (for example, a value representing whether there is a defect) corresponding to the inspection image WF_IMG.

In operation S320, the deep learning system may train the ADC model based on the received training data. In this case, training of the ADC model may be performed by a method which optimizes a parameter of the neural network by repeatedly performing forward propagation on the neural network, gradient calculation using a loss function, and backpropagation.

In operation S330, the deep learning system may perform an inference operation using the ADC model, and thus, may determine a defect of a semiconductor device. In this case, the ADC model used in operation S330 may be a model where training based on operation S310 and operation S320 is completed. For example, the deep learning system may receive a new inspection image and may determine whether the new inspection image has a defect.

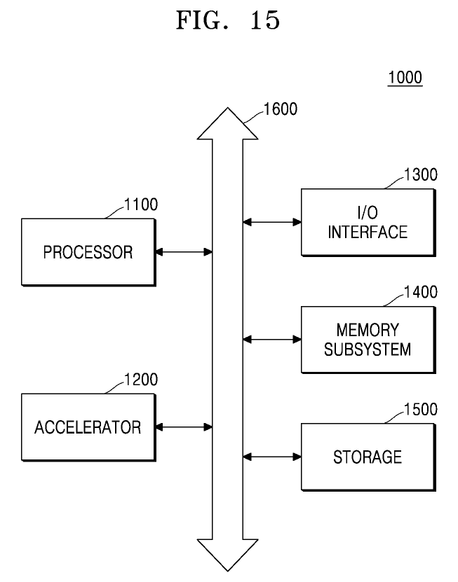

FIG. 15 is a block diagram illustrating a system 1000 according to an embodiment.

Referring to FIG. 15, the system 1000 of FIG. 15 may correspond to the image analysis device 300 of FIGS. 5 and 6. The system 1000 may include a processor 1100, an accelerator 1200, an input/output (I/O) interface 1300, a memory subsystem 1400, a storage 1500, and a bus 1600. The processor 1100, the accelerator 1200, the I/O interface 1300, the memory subsystem 1400, and the storage 1500 may communicate with each other through the bus 1600. In some embodiments, the system 1000 may be a system-on-chip (SoC) where elements are implemented in one chip, and the storage 1500 may be outside the SoC. In some embodiments, at least one of the elements illustrated in FIG. 15 may be omitted in the system 1000.

The processor 1100 may control an operation of the system 1000 in the uppermost layer and may control the other elements of the system 1000.

In some embodiments, the processor 1100 may include two or more processing cores. As described above, the processor 1100 may process various operations needed for an operation of the system 1000 so as to detect an initial defect point of a wafer.

The accelerator 1200 may be designed to perform a designated function at a high speed. For example, the accelerator 1200 may process data received from the memory subsystem 1400, and thus, may provide generated data to the memory subsystem 1400.

The I/O interface 1300 may receive an input from the outside of the system 1000 and may provide an interface for providing an output to the outside of the system 1000. For example, the system 1000 may receive an inspection image WF_IMG and position information CO_INF from the outside.

The memory subsystem 1400 may be accessed by the other elements connected to the bus 1600. In some embodiments, the memory subsystem 1400 may include a volatile memory such DRAM or SRAM, or may include a non-volatile memory such as RRAM or flash memory. Also, in some embodiments, the memory subsystem 1400 may provide an interface on the storage 1500. The storage 1500 may be a storage medium where data is lost even when power thereto is cut off. For example, the storage 1500 may include a semiconductor memory device such as a non-volatile memory, or may include an arbitrary storage medium such as a magnetic card/disk or an optical card/disk.

In an embodiment, the inspection image WF_IMG and the position information CO_INF may be stored in the memory subsystem 1400 or the storage 1500.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein)

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A method of detecting a defect of a semiconductor device in a wafer, the method comprising:
obtaining an inspection image corresponding to the semiconductor device and position information representing positions of a plurality of test element groups in the wafer;
identifying a masking region and a non-masking region from the inspection image, based on the position information;
generating brightness information corresponding to a boundary region included in the inspection image; and
detecting a defect of the semiconductor device by detecting a defect region in the non-masking region, based on the brightness information.

2. The method of claim 1, wherein the inspection image comprises:
a scribe lane image region corresponding to at least a portion of a scribe lane in the wafer; and
a chip image region corresponding to at least a portion of the semiconductor device in the wafer.

3. The method of claim 1, wherein the boundary region corresponds to a scribe lane in the semiconductor device and a boundary surface of a chip in the semiconductor device.

4. The method of claim 3, wherein the brightness information comprises a plurality of gray values respectively corresponding to a plurality of pixels corresponding to the boundary region.

5. The method of claim 1, wherein the identifying of the masking region and the non-masking region comprises:
identifying the masking region from the inspection image, based on the position information and a predetermined margin length; and
identifying, in the image for inspect and as an inspection-targeted region, a region excluding the masking region.

6. The method of claim 5, wherein the masking region comprises a test element group image region corresponding to at least some of the plurality of test element groups, and
wherein the predetermined margin length corresponds to a difference between a length of the masking region a length of the test element group image region.

7. The method of claim 1, wherein the inspection image is generated by emitting light onto the semiconductor device and receiving light reflected from the semiconductor device.

8. The method of claim 1, wherein the detecting of the defect of the semiconductor device comprises:
based on the defect region being detected in the non-masking region, outputting a defect result including a first value representing that a defect is present in the semiconductor device; and
based on the defect region not being detected in the non-masking region, outputting a defect result including a second value representing that a defect is not present in the semiconductor device.

9. The method of claim 1, wherein the non-masking region comprises a normal region and the defect region, and
wherein an average gray value of the defect region is greater than an average gray value of the normal region.

10. The method of claim 1, wherein the non-masking region comprises a first region and a second region, and
wherein the detecting of the defect of the semiconductor device by detecting the defect region from the non-masking region comprises:
determining a first average gray value representing an average of gray values corresponding to the first region;
determining a second average gray value representing an average of gray values corresponding to the second region; and
based on a difference between the second average gray value and the first average gray value being greater than a defect reference gray value, determining the second region as the defect region.

11. The method of claim 1, wherein the detecting of the defect of the semiconductor device comprises determining a region where a gray value is greater than or equal to a reference value, as the defect region in the non-masking region.

12. A device for detecting a defect of a semiconductor device in a wafer, the device comprising:
a stage configured to have the semiconductor device loaded thereon or unloaded therefrom;
an image generating device configured to emit light onto the semiconductor device and generate an inspection image, based on light reflected from the semiconductor device; and
an image analysis device configured to analyze the image for inspect, based on position information representing positions of a plurality of test element groups in the wafer,
wherein the image analysis device is configured to:
identify a masking region and a non-masking region from the inspection image, based on the position information,
generate brightness information corresponding to a boundary region included in the inspection image, and
detect a defect of the semiconductor device by detecting a defect region in the non-masking region, based on the brightness information.

13. The device of claim 12, wherein the inspection image comprises:
a scribe lane image region corresponding to at least a portion of a scribe lane in the wafer: and
a chip image region corresponding to at least a portion of the semiconductor device in the wafer.

14. The device of claim 12, wherein the boundary region corresponds to a scribe lane in the semiconductor device and a boundary surface of a chip in the semiconductor device.

15. The device of claim 12, wherein the image analysis device is configured to:
identify the masking region from the inspection image, based on the position information and a predetermined margin length, and
identity, as the non-masking region, a region excluding the masking region in the inspection image.

16. The device of claim 15, wherein the masking region comprises a test element group image region corresponding to at least some of the plurality of test element groups, and
wherein the predetermined margin length corresponds to a difference between a length of the masking region a length of the test element group image region.

17. The device of claim 12, wherein the light comprises red visible light.

18. The device of claim 12, wherein the brightness information comprises a plurality of gray values respectively corresponding to a plurality of pixels corresponding to the boundary region.

19. The device of claim 12, wherein the non-masking region comprises a normal region and the defect region, and
wherein an average gray value of the defect region is greater than an average gray value of the normal region.

20. A non-transitory computer-readable storage medium storing instructions that, when executed by a processor, cause the processor to:
obtain position information representing positions of a plurality of test element groups and an inspection image corresponding to a semiconductor device;
identify a masking region and a non-masking region from the inspection image, based on the position information;
generate brightness information corresponding to a boundary region included in the inspection image; and
detect a defect of the semiconductor device by detecting a defect region in the non-masking region, based on the brightness information.
